(19) United States
(12) Patent Application Publication
(10) Pub. No.: US 2022/0270294 A1
(43) Pub. Date: Aug. 25, 2022

(54) CALIBRATION METHODS, APPARATUSES, SYSTEMS AND DEVICES FOR IMAGE ACQUISITION DEVICE, AND STORAGE MEDIA

(71) Applicant: Zhejiang SenseTime Technology Development Co., Ltd., Hangzhou (CN)

(72) Inventors: Hujun BAO, Hangzhou (CN); Guofeng ZHANG, Hangzhou (CN); Yuwei WANG, Hangzhou (CN); Yuqian LIU, Hangzhou (CN)

(21) Appl. No.: 17/740,771

(22) Filed: May 10, 2022

Related U.S. Application Data
(63) Continuation of application No. PCT/CN2020/126573, filed on Nov. 4, 2020.

(30) Foreign Application Priority Data
Nov. 19, 2019 (CN) 201911135686.4

(51) Int. Cl. G06T 7/80; G06T 7/13

(52) U.S. Cl. CPC G06T 7/80; G06T 7/13; G06T 2207/30252; G06T 2207/30204

(57) ABSTRACT

Methods, apparatus, systems and computer-readable storage media for calibration of image acquisition devices are provided. In one aspect, a calibration method includes: obtaining one or more images collected by an image acquisition device, the one or more images including information of a plurality of calibration plates with different position-orientation information and without being shaded by each other; detecting corner points corresponding to the plurality of calibration plates in each of the one or more images; and calibrating the image acquisition device based on the detected corner points.

### CROSS-REFERENCE TO RELATED APPLICATION

This application is a continuation of International Application No. PCT/CN2020/126573, filed on Nov. 4, 2020, and claims the priority of Chinese patent application No. 201911135686.4 filed with the Chinese Patent Office on Nov. 19, 2019, the disclosures of which are incorporated herein by reference in their entireties.

### TECHNICAL FIELD

The present disclosure relates to calibration methods, apparatuses, and systems for an image acquisition device, and storage media.

### BACKGROUND

With the development of computer vision technology, higher accuracy is expected for an image undergoing data processing so as to obtain a more accurate processing result. That is, there is an increasing requirement of the accuracy for the image collected by an image acquisition device such as a camera. Take the camera as an instance, the accuracy of the image may be affected by camera parameters. The higher the accuracy of the camera parameters, the better the image can be restored, which means the higher the accuracy of the collected image. And, the camera parameters are determined through calibrating the camera.

### SUMMARY

The embodiments of the present disclosure provide a calibration method, apparatus, and system for an image acquisition device and a storage medium, so as to solve a technical problem that excessive manpower and resources have to be occupied for collecting and processing a large number of images during a calibration process,

In a first aspect, the embodiments of the present disclosure provide a calibration method for an image acquisition device, including: obtaining one or more images collected by the image acquisition device, where the one or more images include information of a plurality of calibration plates with different position-orientation information and without being shaded by each other; detecting corner points corresponding to the plurality of calibration plates in each of the one or more images; and calibrating the image acquisition device based on the detected corner points.

In a second aspect, the embodiments of the present disclosure provide a calibration system for an image acquisition device, including a calibration device for an image acquisition device. The calibration device includes at least one processor; and at least one non-transitory memory coupled to the at least one processor and storing programming instructions for execution by the at least one processor to: obtain one or more images collected by the image acquisition device, wherein the one or more images include information of a plurality of calibration plates with different position-orientation information and without being shaded by each other; detect corner points corresponding to the plurality of calibration plates in each of the one or more images; and calibrate the image acquisition device based on the detected corner points.

In a third aspect, the embodiments of the present disclosure provide a non-transitory computer-readable storage medium coupled to at least one processor having machine-executable instructions stored thereon that, when executed by the at least one processor, cause the at least one processor to perform operations including: obtaining one or more images collected by an image acquisition device, wherein the one or more images include information of a plurality of calibration plates with different position-orientation information and without being shaded by each other; detecting corner points corresponding to the plurality of calibration plates in each of the one or more images; and calibrating the image acquisition device based on the detected corner points.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is an application scenario diagram of calibrating a camera in related art.

FIG. 2A is a schematic diagram of a calibration system for an image acquisition device including a monocular camera according to an example of the present disclosure.

FIG. 2B is a schematic diagram of a calibration system for an image acquisition device including a binocular camera according to an example of the present disclosure.

FIG. 3 is a flowchart of a calibration method for an image acquisition device provided by an example of the present disclosure.

FIG. 4 is a first image and a second image captured by the calibration system for an image acquisition device illustrated in FIG. 2B.

FIG. 5 is a flowchart of a calibration method for an image acquisition device provided by another example of the present disclosure.

FIG. 6 is a schematic diagram of a first image and a second image before corner points are matched according to an example of the present disclosure.

FIG. 7 is a schematic diagram of a first image and a second image after corner points are matched according to an example of the present disclosure,

FIG. 8 is a spatial position diagram of calibration plates collected by a calibrated camera provided by an example of the present disclosure.

FIG. 9 is a schematic structural diagram of a calibration apparatus provided by an example of the present disclosure.

FIG. 10 is a schematic structural diagram of a calibration device provided by example of the present disclosure.

The specific examples of the present disclosure have been illustrated through the above drawings and will be described in more detail below. These drawings and text description are not intended to limit the scope of the conception of the present disclosure in any way, but to explain the concept of the present disclosure fix those skilled in the art by referring to the specific examples.

### DETAILED DESCRIPTION OF THE EMBODIMENTS

Exemplary embodiments will be described in detail here with the examples thereof expressed in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

In the related art, it is mainly to collect multiple images of one calibration plate at different angles and different distances, and then complete a calibration process based on the multiple collected images, In an actual operation process, a calibration personnel can realize the collection of the multiple images by moving the calibration plate or by moving his camera fix multiple times. In order to obtain better calibration effects, it is often necessary to collect a large number of images for calibrating the camera, and it is inevitable in the process of collecting the large number of images to require the calibration personnel to adjust the calibration plate for multiple times such as adjust its placement positions and its angle relative to the camera, or require the calibration personnel to frequently move the camera, so as to obtain the large number of images that meet calibration requirements. And, subsequent processing of the large number of collected images occupies a large amount of processing resources, which consumes manpower and resources.

FIG. 1 is an application scenario diagram of calibrating a camera in the related art. The camera 11 to be calibrated may be a monocular camera or a binocular camera. Taking the binocular camera as an instance, in order to calibrate the camera in the related art, a calibration plate 12 is moved and/or rotated or the camera is manually moved, and then multiple images are captured separately through two camera lenses of the binocular camera (illustrated as two circles on the binocular camera 11 in FIG. 1)). Each image captured by either camera lens contains the calibration plate 12. The calibration plate 12 involved in the multiple images captured by each camera lens presents different positions and orientations, and the images captured by the two camera lenses of the binocular camera on the calibration plate 12 with the same position and orientation are called a group of images. Through being captured repeatedly, multiple groups of images are obtained, such as 10-20 groups. Then, the images that meet the requirements of a calibration algorithm are manually selected. It can be seen that there are the following shortcomings in the related art: 1) manual participation is required to move the calibration plate or the image acquisition device; 2) it is required to manually select the images that meet the requirements of the calibration algorithm; and 3) in the case that the two camera lenses of the binocular camera have poor synchronization, there is a spatial position error between the image data captured by the two camera lenses during moving the calibration plate, which causes a decrease in a calibration accuracy.

The examples of the present disclosure provide a calibration method for an image acquisition device, which aims to solve at least one of the above technical problems. In the examples of the present disclosure, the image acquisition device may be a terminal such as a camera, a camera lens, or a mobile phone or computer with an image acquisition function. As an instance, the technical solutions provided by the examples of the present disclosure are further described below by taking the camera as the image acquisition device.

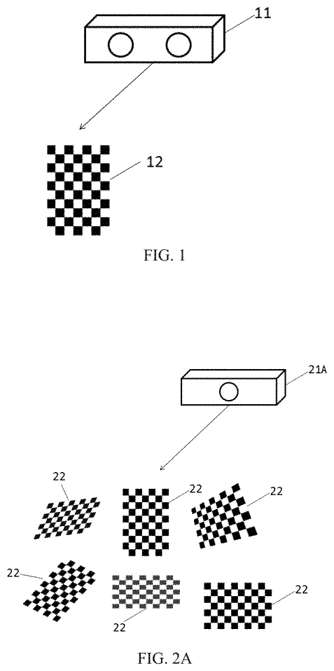

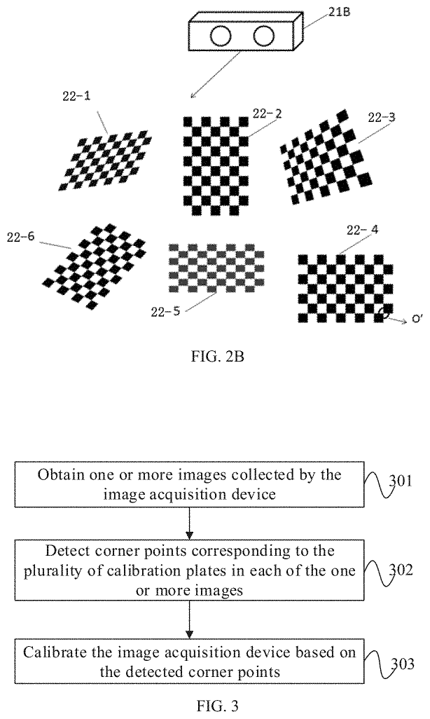

The calibration method for an image acquisition device provided by the examples of the present disclosure is applicable to a calibration system for an image acquisition device illustrated in FIG. 2A or FIG. 2B. As illustrated in FIG. 2A, the calibration system for an image acquisition device includes a monocular camera 21A and a plurality of calibration plates 22. As illustrated in FIG. 2B, the calibration system for an image acquisition device includes a binocular camera 21B and the plurality of calibration plates 22. The plurality of calibration plates 22 in FIG. 2A and FIG. 2B may be selected to have distinctive features such as checkerboards, feature point sets, and feature edges, and the shapes of the calibration plates 22 may be rectangular, circular, irregular graphics, and the like. It should be noted that in the calibration system for an image acquisition device provided by the examples of the present disclosure, the plurality of calibration plates 22 can be made to have different position-orientation information and not to be shaded by each other.

Before the calibration begins, it is allowed to observe all the calibration plates 22 in advance through the monocular camera 21A, and adjust the positions or the orientations of the calibration plates 22 so that all the calibration plates 22 are within a field of view of the camera. lens of the monocular camera 21A at the same time, are completely visible, and cover the field of view of the monocular camera 21A as far as possible, especially edge parts of the image captured by the camera lens. Or, it is allowed to observe all the calibration plates 22 in advance through the binocular camera 21B, and adjust the positions or the orientations of the calibration plates 22 so that all the calibration plates 22 are within the fields of view of the two camera lenses of the binocular camera 21B respectively, are within the fields of view of the two camera lenses of the binocular camera 21B at the same time, are completely visible, and cover the fields of view of the binocular camera 21B as far as possible, especially the edge parts of the image captured by each camera lens.

A view of the camera refers to a region that can be seen through the camera. The field of view refers to a range corresponding to a region where images can be acquired by the camera. In the examples of the present disclosure, the field of view of the camera may be determined based on one or more of the following parameters: a distance from the lens to an object, a model or size of the camera, a focal length of the lens, etc. For example, if the distance from the lens to the object is 1500 mm, the model or size of the camera is 4.8 mm, and the focal length of the lens is 50 mm, then the view of the camera=(1500*4.8)/50=144 mm. The field of view of the camera can be understood as a field of view angle of the camera, i.e. an angle formed from a center of the camera lens to both diagonal of its imaging plane. For the same imaging area, the shorter the focal length of the lens, the larger the field of view angle.

In addition, in these examples, it is also expected that all the calibration plates 22 are not shaded by each other or not shaded by another object. When the plurality of calibration plates 22 are not shaded by each other, it can be understood that there is no overlap between the plurality of calibration plates 22 in the field of view observed by the camera, and each of the plurality of calibration plates 22 is complete. That is, there is no overlap between the reflections of the plurality of calibration plates included in the captured image, and the image includes the complete reflection of the plurality of calibration plates. Therefore, when the plurality of calibration plates 22 are arranged, any two calibration plates 22 are separated by a certain distance, instead of being closely next to each other. When the plurality of calibration plates 22 are arranged, at least two of the plurality of calibration plates 22 may have different horizontal distances to the camera, so that the position information of the calibration plates involved in the image collected by the camera is more diversified. This means that the calibration plates 22 within various distance ranges from the camera are involved in a single collected image. For example, the field of view of the camera is divided into 3 dimensions, which are a short distance, a moderate distance, and a long distance from the camera, respectively, In this way, at least the calibration plate 22 within the above three dimensions are involved in the single collected image, so that the position information of the calibration plates involved in the collected image is diversified.

In addition, it can achieve to make the reflections of the calibration plates in the collected image clearer by ensuring the calibration plates 22 flat. For example, by fixing the periphery of the calibration plate 22 through a position limiting device such as an aluminum alloy frame, the characteristic data such as the graphics and point sets presented on the calibration plate are clearer.

It should be noted that the number of the calibration plates 22 in FIGS. 2A and 2B is only illustrative, and should not be understood as a limitation on the number of the calibration plates 22. Those skilled in the art can arrange the corresponding number of calibration plates 22 according to actual conditions.

The system illustrated in FIGS. 2A and 2B according to the examples of the present disclosure can be used to calibrate a vehicle-mounted camera, so as to provide a basis for realizing automatic driving. It can also be used to calibrate a robot equipped with a vision system, so as to improve an accuracy of various operations performed by the robot based on the vision system. Taking the vehicle-mounted camera on a self-driving vehicle as an instance, the calibration system for an image acquisition device illustrated in FIG. 2A can calibrate a vehicle-mounted monocular camera, and the calibration system for an image acquisition device illustrated in FIG. 2B can calibrate a vehicle-mounted binocular camera.

The technical solutions of the present disclosure, as well as how the technical solutions of the present disclosure solve the above technical problems, will be described in detail below with specific examples. The following specific examples can be combined with each other, and the same or similar concepts or processes may not be repeated in some examples. The examples of the present disclosure will be described below in conjunction with the accompanying drawings.

FIG. 3 is a flowchart of a calibration method for an image acquisition device provided by an example of the present disclosure. The examples of the present disclosure provide the calibration method for an image acquisition device for the above technical problems in the related art. The detailed steps of the method are as follows.

At step 301, one or more images collected by the image acquisition device are obtained.

The one or more images involve the plurality of calibration plates with different position-orientation information and without being shaded by each other.

In the example, if being deployed on the vehicle, the image acquisition device may be the vehicle-mounted monocular camera or the vehicle-mounted binocular camera.

The above-mentioned position-orientation information refers to a position state of each calibration plate in space, which may specifically include position information and orientation information. The position information refers to a relative positional relationship between the calibration plate and the camera, and the orientation information refers to an orientation of the calibration plate on the position indicated by the position information, such as rotation and pitch/elevation. In the example of the present disclosure, the position-orientation information may also refer to information of the calibration plate corresponding to at least one of 6 dimensions of space. Thus, when the position-orientation information is different, it means that the information in at least one dimension of space is different. The 6 dimensions refer to shift information and rotation information of the calibration plate separately on X axis, Y axis and Z axis of a three-dimensional coordinate system.

Alternatively or additionally, when the image acquisition device includes the monocular camera, which performs the capture through, for example, the calibration system illustrated in FIG. 2A, the one or more images include one image collected using the camera lens of the monocular camera or at least two images collected for multiple times. The multiple collected images may be captured by the monocular camera in the same state continuously or at a regular interval, or may be captured by the monocular camera as the state changes, which means that at least two of the multiple images were captured by the monocular camera in different states. The state of the monocular camera refers to the position of the monocular camera in space, and/or the pitch/elevation of the monocular camera, etc.

Alternatively or additionally, when the image acquisition device includes the binocular camera, which performs the capture through, for example, the calibration system illustrated in FIG. 2B, the one or more images include a first image collected using a first camera lens of the binocular camera and a second image collected using a second camera lens of the binocular camera, The first image and the second image respectively involve the plurality of calibration plates. Multiple first images and multiple second images are obtained in a similar way as the implementation of the above-mentioned monocular camera, which will not be repeated here. In the actual capturing process, the first camera lens and the second camera lens often complete one capture within a certain time range, and the first image and the second image obtained by completing the capture within the certain time range can be regarded as a group of images for the subsequent calibration process of the binocular camera.

In one example, the plurality of calibration plates are completely involved in the one or more images captured by the image acquisition device.

In the example, the multiple images collected by the image acquisition device may be images of multiple frames which are in a video sequence collected by the image acquisition device in recording or another way and are adjacent or non-adjacent in time sequence.

At step 302, corner points corresponding to the plurality of calibration plates in each of the one or more images are detected.

Alternatively or additionally, when the image acquisition device includes the monocular camera, in this step, it is to perform the corner point detection on at least one image collected using the camera lens of the monocular camera.

Alternatively or additionally, when the image acquisition device includes the binocular camera, in this step, it is to perform the corner point detections separately on the first image collected using the first camera lens of the binocular camera and the second image collected using the second camera lens of the binocular camera.

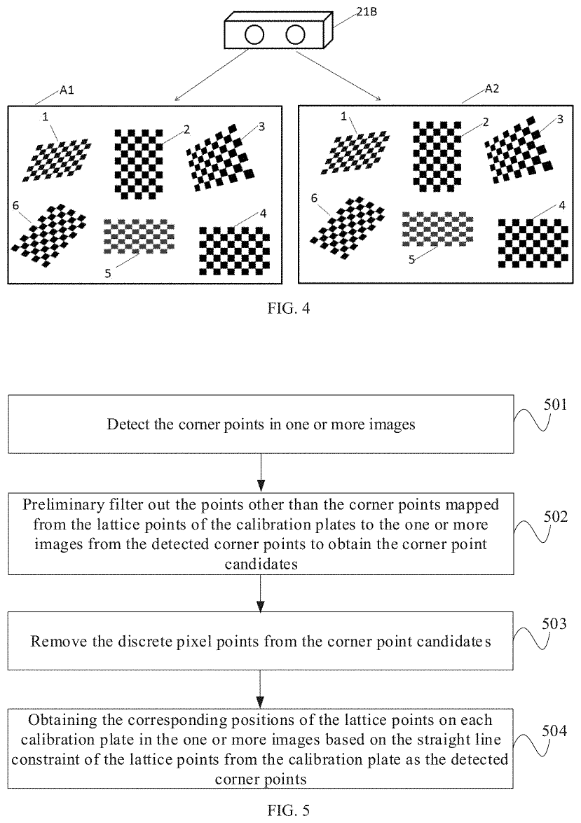

In the example, the corner points refer to pixel points in the image mapped from lattice points of the calibration plates. Generally, the local maximum value in the image can be regarded as a corner point. For example, if being brighter or darker than its surrounding pixel points, one pixel point can be regarded as the corner point. As illustrated in the first image A1 and the second image A2 in FIG. 4, the pixel points corresponding to the intersection of ever two lines of the checkerboard on the calibration plate can be detected as corner points. The lattice point of the calibration plates refers to the intersection of two lines used to divide a black grid and a white grid when the calibration plates have a checkerboard pattern, that is, a vertex of a rectangle on the calibration plates indicating the black grid or the which grid. For example, the lattice point O′ illustrated in FIG. 2B (pointed by the arrow on the right in FIG. 2B).

Illustratively, detecting the corner points corresponding to the plurality of calibration plates in the one or more images may mean detecting the corner points corresponding to at least two of the plurality of calibration plates in the one or more images. For example, if there are 20 calibration plates in the calibration system, one or more images containing a part or all of the calibration plates may be collected by the image acquisition device, for example, an image involving 18 calibration plates. In this way, the corner points corresponding to the 18 calibration plates in the image can be detected. Of course, it is also possible to detect the corner points corresponding to less than 18 calibration plates in the image. For example, in the image involving 18 calibration plates, the corner points corresponding to 15 calibration plates thereof are detected in the image.

At step 303, the image acquisition device is calibrated based on the detected corner points.

In the example of the present disclosure, calibrating the image acquisition device means that at least one of the following parameters of the image acquisition device can be calibrated: intrinsic parameters, extrinsic parameters, and the like.

As an instance where the camera is taken as the image acquisition device, the intrinsic parameters of the camera refer to the related parameters reflecting the characteristics of the camera itself, which can include, but not limited to, one of the following parameters or the combination thereof: the focal length of the camera, an image resolution, and the like; and the extrinsic parameters of the camera refer to the parameters of a positional relationship of an object with respect to the camera in a world coordinate system which can include, but not limited to, one of the following parameters or the combination thereof: a distortion parameter of the images collected by the camera, a conversion relationship from a certain point in space to the camera coordinate system, and the like.

The above illustration of the intrinsic parameters and extrinsic parameters are only an instance, and is not intended to limit the intrinsic parameters and extrinsic parameters of the camera.

In the example of the present disclosure, calibrating the intrinsic parameters and/or the extrinsic parameters of the image acquisition device is taken as an instance for illustration.

Alternatively or additionally, after the corner point detection is performed on the one or more images, a calibration algorithm and the detected corner points may be used to calibrate the parameters of the camera. The calibration algorithm may adopt the existing calibration algorithm, such as Zhengyou Zhang calibration.

For the monocular camera, calibrating the image acquisition device based on the detected corner points means to determine the intrinsic parameters of the monocular camera based on the detected corner points. For example, the detected corner points may be globally optimized to obtain the intrinsic parameters of the monocular camera. For example, the Zhengyou Zhang calibration may be adopted to calibrate the detected corner points to obtain first intrinsic parameters of the monocular camera; and the first intrinsic parameters may be optimized to obtain final intrinsic parameters of the camera. Optimizing the first intrinsic parameters may include: establishing an objective function based on the detected corner points and projection points projected in the image from the lattice points on the calibration plates; and seeking an optimal solution to the objective function to obtain second intrinsic parameters of the monocular camera, which are the final intrinsic parameters of the monocular camera. The lattice points on the calibration plates may be projected in the one or more images through a projection functional relationship based on the first intrinsic parameters, the coordinates in the camera coordinate system of the corner points, and a conversion relationship between a calibration plate coordinate system and the camera coordinate system, so as to obtain the projection points projected in the one or more images from the lattice points on the calibration plates. In this way, a corner point error corresponding to each calibration plate can be minimized, the detected corner point positions can be optimized, and a detection accuracy of the camera. can be improved.

For the binocular camera, calibrating the image acquisition device based on the detected corner points means matching the detected corner points in the first image with the detected corner points in the second image, and determining the intrinsic and the extrinsic parameters of the binocular camera based on the corner points that are successfully matched. For example, the corner points that are successfully matched may be globally optimized to obtain final intrinsic parameters and final extrinsic parameters of the binocular camera. For example, the Zhengyou Mang calibration may be adopted to calibrate the detected corner points to obtain first intrinsic parameters of the binocular camera; a Perspective-n-Point (PnP) algorithm may be adopted to calibrate the detected corner points to obtain first extrinsic parameters of the binocular camera; and the first intrinsic parameters and the first extrinsic parameters may be optimized to obtain the final intrinsic parameters and the final extrinsic parameters of the camera. Optimizing the first intrinsic parameters and the first extrinsic parameters may include: establishing an objective function based on the detected corner points and projection points projected in the one or more images from the lattice points on the calibration plates; and seeking an optimal solution to the objective function to obtain second intrinsic parameters and second extrinsic parameters of the binocular camera, which are the final intrinsic parameters and the final extrinsic parameters of the binocular camera. The lattice points on the calibration plates may be projected in the one or more images through a projection functional relationship based on the first intrinsic parameters, the first extrinsic parameters, the coordinates in the camera coordinate system of the corner points, and a conversion relationship between a calibration plate coordinate system and the camera coordinate system, so as to obtain the projection points projected in the one or more images from the lattice points on the calibration plates. In this way, the corner point error corresponding to each calibration plate can be minimized and the detected corner point positions can be optimized.

In the example of the present disclosure, the corner point detection is performed on the one or more images collected by the image acquisition device to determine the corner points corresponding to the plurality of calibration plates involved in the one or more images, and then the image acquisition device is calibrated based on the detected corner points. In a single image, there involve a plurality of calibration plates with different position-orientation information and without being shaded by each other. That is, the image includes information of the plurality of calibration plates, e.g., their reflections.

Since the one or more images for calibrating the image acquisition device are collected in such a scenario that the plurality of calibration plates with different position-orientation information and without being shaded by each other are contained, the manpower that has to be consumed to manually move and/or rotate the calibration plates or manually move the image acquisition device can be saved during the image collection process. Moreover, since the single image involves the plurality of calibration plates and each calibration plate is suitable for calibrating the image acquisition device, the number of images to be processed can be greatly reduced, thereby saving resources for image processing.

In addition, since the amount of information included in the single image is equivalent to the amount of information included in multiple images in the related art, the time spent on the image collection is also saved, and in general, additional manual screening on the collected images may also be omitted.

In addition, since the calibration plates may be always kept in a static state during the image collecting process, for the image acquisition device with multiple camera lenses, it can effectively reduce a synchronization requirement of the multiple camera lenses, thereby improving the calibration accuracy.

Alternatively or additionally, detecting the corner points corresponding to the plurality of calibration plates in each of the one or more images includes: determining corner point candidates in the one or more images; and clustering the corner point candidates in the one or more images to obtain the corner points corresponding to the plurality of calibration plates in the one or more images. The corner point candidates refer to the corner points corresponding to the lattice points of the calibration plates. In the example, pixel points belonging to the calibration plates in the one or more images can be obtained through clustering the corner point candidates. The points in the corner point candidates, which do not belong to the calibration plates, can be filtered out via being clustered, thereby de-noising the image. Its detailed implementation process may be that, a certain pixel point in the one or more images is taken as a reference point to determine a neighborhood in the one or more images, a similarity between a pixel point in the neighborhood and the current pixel point is calculated, and the pixel point in the neighborhood is regarded as a similar point of the current pixel point if the similarity is less than a preset threshold. Alternatively or additionally, the similarity may be measured by a sum of squared difference (SSD). In the example of the present disclosure, other similarity calculation approaches may also be adopted for the measure. The preset threshold may be set in advance, and especially, may be adjusted according to different patterns on the calibration plates. The value of the preset threshold is not limited here.

For the monocular camera, the corner point candidates in one image may be determined or the corner point candidates in multiple images may be determined separately. And, the corner point candidates in each image are clustered to obtain the corner points corresponding to the plurality of calibration plates in each image.

For the binocular camera, the corner point candidates in the first image and the second image may be determined respectively. And, the corner point candidates in the first image and the second image are clustered respectively to obtain the corner points corresponding to the plurality of calibration plates in the first image and the second image. It should be noted that there may be one first image, and correspondingly, there may be one second image. Of course, when there are multiple first images, there may he multiple corresponding second images. And, the number of the first images is the same as that of the second images, and the first images and the second images may be in one-to-one correspondence.

Alternatively or additionally, determining the corner point candidates in the one or more images may include: detecting the corner points in the one or more images; from the detected corner points, preliminarily filtering out the points other than the corner points mapped from the lattice points of the calibration plates to the one or more images, so as to obtain the corner point candidates. The detected corner points include the corner points mapped from the lattice points of the calibration plates to the one or more images, and may also include other misdetected points. Therefore, the corner point candidates can be obtained by filtering out the misdetected points. Alternatively or additionally, a non-maximum suppression approach may be adopted to preliminarily filter out the points other than the corner points mapped from the lattice points of the calibration plates to the one or more images, for example, the misdetected points. Through the example, the corner points that do not belong to the lattice points of the calibration plates can be preliminarily filtered out in the one or more images, so as to achieve a preliminary denoising.

Alternatively or additionally, after obtaining the corner point candidates from the detected corner points via preliminarily filtering out the points, e.g., the misdetected points, other than the corner points mapped from the lattice points of the calibration plates to the one or more images, the method further includes: clustering the corner point candidates in the one or more images to filter out discrete pixel points from the corner point candidates. Through the example, on the basis of the previous denoising, the number of the corner points in the one or more images can be determined based on the number of the lattice points on the calibration plates. Moreover, according to the character that the lattice points of the calibration plates are distributed regularly, the pixel points that do not belong to the corner points corresponding to the lattice points on the calibration plates can he filtered out. For example, for a 6*10 calibration plate with 5*9=45 lattice points, there should be 45 corresponding corner points in each image. The above step is to filter out other pixel points than these 45 corner points. Through the example, the corner points that do not belong to the lattice points of the calibration plates can be further filtered out in the one or more images, so as to achieve a further denoising.

Alternatively or additionally, after clustering the corner point candidates in the one or more images to obtain the corner points corresponding to the plurality of calibration plates in the one or more images, the method further includes: correcting positions of the clustered corner points based on a straight line constraint relationship of the lattice points from the calibration plates. In the example, the corner points corresponding to the lattice points on each calibration plate can be obtained after clustering the corner point candidates, but their positions may be inaccurate. For example, for three lattice points in one straight line on the calibration plates, there should be three corresponding corner points in one straight line in the one or more images. As an instance, A (1, 1), B (2, 2) and C (3, 3) should locate in the one straight line in the one or more images. However, for the clustered corner points, there may be one corner point falling out of the straight line, for example, the coordinates of the clustered corner points are A (1, 1), B (2, 2) and C (3.1, 3.3). Thus, it is to correct the corner point C to (3, 3), so that the corner point C can lie in the same straight line as the other two corner points A and B. Through the correction process of this step, the detected corner points can present more accurate positions, thereby improving the calibration accuracy in the subsequent calibration process.

The above processes are described in detail through a complete example below. In this example, the binocular camera is taken as an instance for description. It can also be implemented in a similar manner through the monocular camera, which will not be repeated here.

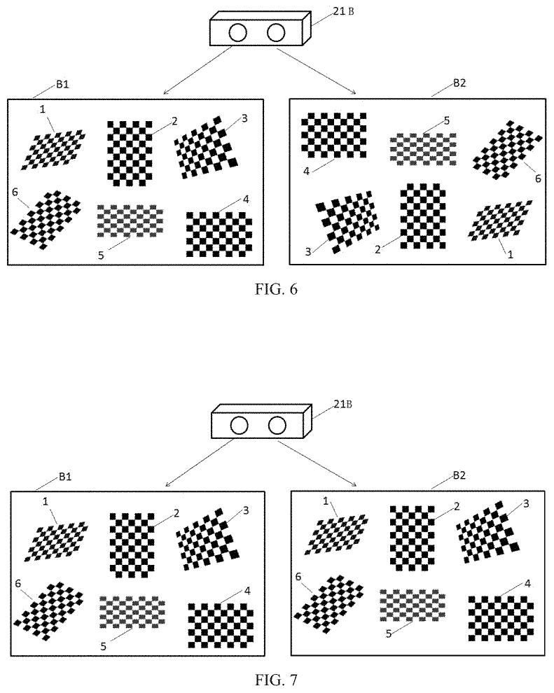

FIG. 5 is a flowchart of a calibration method for an image acquisition device provided by another example of the present disclosure. The calibration method for an image acquisition device specifically includes the following steps.

At step 501, the corner points in one or more images are detected.

In particular, the corner points are detected according to an existing corner point detection algorithm. Taking the binocular camera as an instance, in this step, it is to detect the corner points in the first image and the second image respectively. Alternatively or additionally, this step may include: finding all possible pixel-level corner points in the one or more images according to the existing corner point detection algorithm, and further refining the corner points to a sub-pixel level based on image gradient information.

At step 502, the points, e.g., the misdetected points, other than the corner points mapped from the lattice points of the calibration plates to the one or more images are filtered out from the detected corner points to obtain the corner point candidates.

Alternatively or additionally, this step may include that it may preliminarily filter out the points other than the corner points mapped from the lattice points of the calibration plates to the one or more images by adopting the non-maximum suppression approach. For example, the non-maximum suppression approach may be adopted to preliminarily filter out the misdetected points.

At step 503, the discrete pixel points are removed from the corner point candidates.

In particular, since the lattice points on the calibration plates are regularly distributed, in this step 503, the corner point candidates can be clustered to remove those discrete pixel points, so as to further filter out the noisy pixel points.

Since the one or more images of this example involve a plurality of calibration plates and the pixel points corresponding to each calibration plate should be continuous and dense, through the clustering approach, the position corresponding to each calibration plate can be roughly divided and the points other than the corner points corresponding to the lattice points of the calibration plates can be filtered out.

Since the number of the lattice points on the calibration plates is known, in general, the number of the corner points on the reflection of each calibration plate is determined in the one or more corresponding images. Therefore, the denoising can be performed in accordance with the relationship that the number of the lattice points of the calibration plates is the same as the number of the corner points in the one or more images.

At step 504, the corresponding positions of the lattice points on each calibration plate in the one or more images are obtained based on the straight line constraint of the lattice points from the calibration plate, as the detected corner points.

Alternatively or additionally, after the corresponding positions of the lattice points on each calibration plate in the one or more images are divided in the step 503, the pixel points in the one or more images, which correspond to the lattice points on each calibration plate, may be treated based on the straight line constraint of the lattice points from the calibration plate, so as to obtain the positions of the corner points corresponding to the lattice points of each calibration plate. The straight line constraint of the lattice points from the calibration plate refers to the relationship that the pixel points corresponding to the lattice points on the calibration plates are distributed on the same straight line.

In particular, for each calibration plate, the positions of the detected corner points are stored in a matrix form. Supposing that the number of the calibration plates is N, N matrices can be obtained through the corner point detection approach provided by this example. For example, there are 6 calibration plates in the calibration system for an image acquisition device illustrated in FIGS. 2A and 2B. and thus for each image, 6 matrices can be obtained through the corner point detection approach provided by this example to indicate the positions of the detected corner points.

Alternatively or additionally, when the image acquisition device includes the monocular camera, the camera parameters can be directly obtained through a global optimization after the corner point detection.

Alternatively or additionally, when the image acquisition device includes the binocular camera, for one three-dimensional point in space, it has to find its position in the binocular camera. After the corner point detection is performed through the foregoing steps of the above-mentioned example, the order of the calibration plates and the order of the corner points in the first image may be inconsistent with those in the second image, so it is necessary to match the calibration plates involved in the first image and those involved in the second image, and then to match the corner points corresponding to the lattice points on the matched calibration plates to facilitate subsequent camera calibration. Supposing that the first image and the second image are marked as A1 and A2, respectively, matching the calibration plates involved in the first image and those involved in the second image means to find the reflections of one calibration plate in the first image A1 and the second image A2 and realize the correspondence of the two reflections. For example, it may realize the correspondence of the positions of one calibration plate in the first image and the second image in the system illustrated in FIG. 2B. For example, supposing that the six calibration plates 22 in FIG. 2B are numbered as 1, 2, 3, 4, 5, and 6, respectively, the positions mapped from No. 1, 2, 3, 4, 5 and 6 calibration plates 22 may be found in the first image and the second image separately, and the calibration plates at two corresponding positions found may be matched.

Alternatively or additionally, matching the plurality of calibration plates involved in the first image with the plurality of calibration plates involved in the second image includes: determining a disparity between the first image and the second image; and matching the plurality of calibration plates involved in the first image with the plurality of calibration plates involved in the second image based on the disparity.

In an optional implementation, determining the disparity between the first image and the second image includes: determining an overall displacement of the reflections of the plurality of calibration plates in the second image with respect to the reflections of the plurality of calibration plates in the first image, and determining the overall displacement as the disparity. In particular, it may calculate the overall displacement of the reflections of the plurality of calibration plates in the second image with respect to the reflections in the first image, or calculate the overall displacement of the reflections of the plurality of calibration plates in the first image with respect to the reflections in the second image. And, the overall displacement is taken as the disparity between the first image and the second image. In this example, a binocular disparity refers to the difference between the first image and the second image obtained by the two camera lenses of the binocular camera in the calibration system illustrated in FIG. 2B. By observing the first image A1 (referred to as a left view) and the second image A2 (referred to as a right view) in FIG. 4, it can be found that the reflections of the calibration plates in the right view A2 of the binocular camera as a whole shift to right by a few pixels relative to the reflections of the calibration plates in the left view A1 as a whole. Therefore, by determining the disparity between the first image and the second image, the plurality of calibration plates involved in the first image and the plurality of calibration plates involved in the second image can be matched based on the disparity. This approach is simple and easy to be calculated, which can quickly determine the disparity between the first image and the second image.

Continue to refer to FIG. 4, it can be seen that the distance between the center of all the reflections of the calibration plates in the second image A2 and the left edge of the second. image is greater than the distance of the center of all the reflections of the calibration plates in the first image A1 and the left edge of the first image. The difference of these distances is a pixel distance that the first image A1 shifts to left relative to the second image A2. Therefore, the pixel distance shifted between the first image and the second image may also be calculated as the disparity between the first image and the second image. In addition, it can be seen from FIG. 4 that the distance between the center of all the reflections of the calibration plates in the first image A1 and the right edge of the first image is greater than the distance of the center of all the reflections of the calibration plates in the second image A2 and the right edge of the second image. Therefore, the pixel distance that the second image A2 shifts to right relative to the first image A1 may also be calculated as the disparity between the first image and the second image.

In another optional implementation, determining the disparity between the first image and the second image includes: obtaining the binocular disparity of the binocular camera, and determining the binocular disparity of the binocular camera as the disparity between the first image and the second image. In this example, the binocular disparity refers to the difference between a observation result of the first camera lens and that of the second camera lens when the plurality of calibration plates illustrated in FIG. 2B are observed through the two camera. lenses of the binocular camera. In this example, since the disparity between the first image and the second image is essentially brought by the binocular disparity of the binocular camera, the disparity between the first image and the second image can be determined via determining the binocular disparity of the binocular camera.

Alternatively or additionally, the binocular disparity of the binocular camera may be calculated through the following steps: calculating a product of a focal length of the binocular camera and a baseline length of the binocular camera; and dividing the product by a depth of a calibration plate as the overall displacement. The baseline length of the binocular camera refers to the distance between the two camera lenses of the binocular camera, for example, the distance between the centers of the two camera lens. The approach of calculating the binocular disparity may be simplified to the following equation:

D=f*baseline/depth

In this formula, D is the binocular disparity, f is the focal length of the binocular camera, baseline is the baseline length of the binocular camera, and depth is the depth corresponding to the calibration plate, i.e., a vertical distance from the calibration plate to the baseline of the binocular camera. The depth corresponding to the calibration plate may be determined by adopting a double E1 disparity depth measurement.

Alternatively or additionally, matching the plurality of calibration plates involved in the first image and the plurality of calibration plates involved in the second image based on the disparity includes the following two optional implementations.

In the first optional implementation, matching the plurality of calibration plates involved in the first image and the plurality of calibration plates involved in the second image based on the disparity includes: for each calibration plate of the plurality of calibration plates, determining a first position coordinate in the first image corresponding to a preset position of the calibration plate; determining a second position coordinate in the second image corresponding to the preset position based on the first position coordinate and the disparity between the first image and the second image; and determining that the calibration plate indicated by the second position coordinate in the second image is matched with the calibration plate indicated by the first position coordinate in the first image, so as to determine the matching relationship between the calibration plate involved in the first image and the calibration plate involved in the second image. Alternatively or additionally, since the closer to the center of the calibration plate is, the more likely it is to uniquely determine the calibration plate, it usually selects a position close to the center of the calibration plate, but tries to avoid a position close to the edge of the calibration plate, as the preset position. It is more accurate to uniquely determine the calibration plate based on the pixel point corresponding to the position near the center of the calibration plate, thereby making the determined matching relationship between the calibration plate involved in the first image and the calibration plate involved in the second image more accurate in this way.

In a second optional implementation, matching the plurality of calibration plates involved in the first image and the plurality of calibration plates involved in the second image based on the disparity includes: for each calibration plate of the plurality of calibration plates, determining a second position coordinate in the second image corresponding to a preset position of the calibration plate; determining a first position coordinate in the first image corresponding to the preset position based on the second position coordinate and the disparity between the first image and the second image; and determining that the calibration plate indicated by the first position coordinate in the first image is matched with the calibration plate indicated by the second position coordinate in the second image, so as to determine the matching relationship between the calibration plate involved in the first image and the calibration plate involved in the second image.

It takes the first implementation as an instance with referring to FIG. 4. For example, the position coordinates of the center of the calibration plate No. 1 involved in the first image A1 is added by the binocular disparity to obtain a position coordinate. The calculated position coordinate is the position coordinates of the center of the calibration plate No. 1 involved in the second image A2. The corresponding corner point can be determined in the second image A2 based on the calculated position coordinate, and then the reflection corresponding to the calibration plate No. 1 involved in the first image A1 can be obtained in the second image A2. And, the calibration plate No. 1 involved in the first image A1 and the calibration plate No. 1 involved in the second image A2 can be matched up with each other. In this way, the matching relationships of the six calibration plates between the first image and the second image can be obtained separately. For the second optional implementation, it may refer to the operations taken in the example of the first implementation as described in this paragraph, and the detailed process will not be repeated.

Alternatively or additionally, after the calibration plates are successfully matched, the corner points corresponding to the lattice points of two calibration plates which have been successfully matched can be arranged in a preset order, for example, sorted by row or column, and then the method steps provided by the example are executed by row or column. Generally, since it is to match the same calibration plate involved in different images in response to matching the calibration plates involved in multiple images in the above example and the orientations of the calibration plate may change, it is also to adjust the orientation of the calibration plate involved in one of the images, so that the orientations of the same calibration plate involved in the first image and the second image are also the same. The orientation information of the calibration plate refers to the direction information and/or location information of the calibration plate in the image collection process. Taking the direction information as an instance, the calibration plate is placed in a horizontal state when the first image is collected and in a vertical state when the second image is collected, where the horizontal and vertical directions can be the orientation information of the calibration plate.

Alternatively or additionally, after matching the plurality of calibration plates involved in the first image and the plurality of calibration plates involved in the second image based on the disparity, the method provided by the example further includes: determining the corner points in the second image that correspond to the corner points in the first image based on the coordinates of the corner points detected in the first image and the disparity, so as to match the orientations of the matched calibration plates involved in the first image and the second image.

In particular, after matching the plurality of calibration plates involved in the first image and the plurality of calibration plates involved in the second image based on the disparity, the method provided by the example further includes: in response to failing to determine the corner points in the second image that correspond to the corner points in the first image based on the coordinates of the corner point detected in the first image and the disparity, transposing and/or rotating the matrix of the corner points in the second image at least once until the corresponding corner points are matched, so as to match the orientations of the matched calibration plates involved in the first image and the second image.

As illustrated. in FIG. 6, it is assumed that the calibration plates involved in the first image and the calibration plates involved in the second image have been matched. It can be seen that the arrangement of the calibration plates involved in the first image B1 and that in the second image B2 are different with the second image B2 rotating 180 degrees relative to the first image B1, which will result in an unsuccessful match between the corner points corresponding to two matchable calibration plates. By transposing and/or rotating the matrix of the corner points corresponding to each calibration plate in the second image B2, a result diagram of matching the corner points can be obtained as illustrated in FIG. 7. It can be seen from FIG. 7 that after the corner points are matched, the arrangement of the six calibration plates involved in the first image B1 and that in the second image B2 are the same.

In this example, when the corresponding corner points are not matched in the second image based on the coordinates of the corner points detected in the first image and the disparity, or are not matched in the first image based on the coordinates of the corner points detected in the second image and the disparity, it is considered that the corner point matrix in the second image does not correspond to the corner point matrix in the first image. At this time, it can be considered that the inconsistency of the orientations of a calibration plate leads to the inconsistent order of its corner points. Therefore, it is possible to perform multiple matching by transposing and/or rotating the corner point matrix for multiple times until the corresponding corner points is matched, so that the orientations of the calibration plate involved in the first image and the second image can be matched.

Alternatively or additionally, when calibrating the image acquisition device based on the detected corner points, the method further includes: performing the global optimization on the matching relationship between the corner points corresponding to the lattice points on at least two calibration plates in multiple images to obtain the final extrinsic parameters of the camera. The extrinsic parameters of the camera may be a translation relationship and a rotation relationship between the coordinate systems of the two camera lens of the binocular camera. In this example, a non-linear optimization approach may be adopted in the global optimization, so as to minimize the error of the corner points corresponding to the lattice points in each calibration plate.

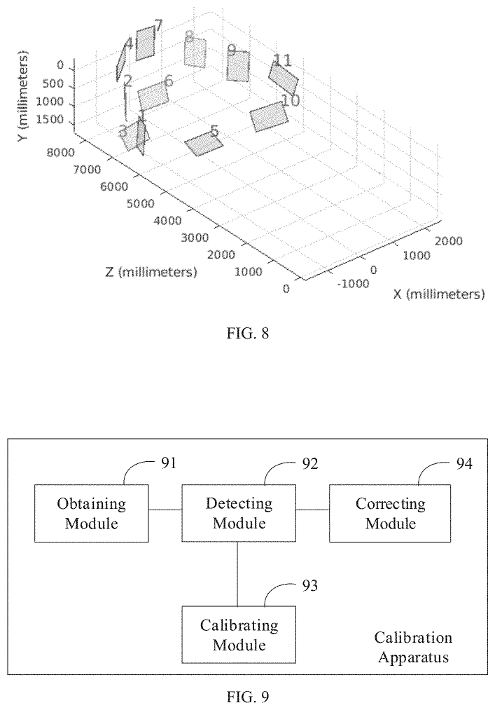

As illustrated in FIG. 8, after the image acquisition device is calibrated through the above-mentioned examples, a recognition result diagram can be obtained through collecting the images of the calibration plates through the calibrated camera. It can be seen that the methods of these examples can more accurately identify the plurality of calibration plates involved in the one or more images, without manually moving and/or rotating the calibration plates or manually moving the image acquisition device. Moreover, since the single image involves the plurality of calibration plates and each calibration plate is suitable for calibrating the image acquisition device, the number of images to be processed can be greatly reduced, thereby saving resources for image processing. In these examples, image data of the plurality of calibration plates can be obtained from one image, which saves the time spent on the image collection, and generally does not require additional manual screening on the collected images. Therefore, the total image collection time required for calibrating the image acquisition device is reduced, and it does not need to waste manpower to select image data that meets the calibration requirements from multiple sets of image data involving only one calibration plate, which reduces the time of sampling the image data. In addition, since the calibration plates may be always in a static state during the image collecting process, for the image acquisition device with multiple camera lenses, it can effectively reduce a synchronization requirement of the multiple camera lenses, thereby improving the calibration accuracy.

When calibrating the camera deployed on a vehicle, it may calibrate the camera deployed inside the vehicle so as to overcome an impact of a windshield on the camera calibration process. That is, the plurality of calibration plates are placed in the field of view of the camera inside the vehicle and are ensured to not be shaded during imaging. Being shaded means that the plurality of calibration plates are shaded by each other, and/or are shaded by an external object such as an accessory suspended in the vehicle and a sign pasted on the windshield of the vehicle during imaging. The image collection may be achieved when the vehicle is in a static state or in a moving state for completing the calibration of the camera inside the vehicle. Similarly, the technical solutions provided by the examples of the present disclosure are also applicable to calibrating the camera on other transportation facilities similar to the vehicle or other objects where the camera can be deployed.

The examples provided by the present disclosure are suitable for a vehicle-mounted camera and another carrier equipped with an image acquisition device such as an intelligent robot or an unmanned drone equipped with an image acquisition device. They are especially suitable for such a scenario that the image acquisition device is difficult to be moved as being fixed on the carrier and only the calibration plates can be moved, thereby completing the calibration of the image acquisition device without moving the image acquisition device.

In addition, for the vehicle-mounted camera or the unmanned drone equipped with a camera, since surrounding environment information often affects the safety of the automatic driving or flying, its collection is very important for the automatic driving of the vehicle or the flight of the unmanned drone. Through the calibration methods of these examples to calibrate the vehicle-mounted camera or the unmanned drone, the calibration accuracy can be improved, so that an accuracy of the collected surrounding environment information is also higher. Correspondingly, for other functions of the vehicle or the unmanned drone such as a positioning function and a ranging function, the accuracy will also be improved, thereby improving the safety of the unmanned driving or flying. For the robot, the increase in the calibration accuracy can improve an accuracy of various operations performed by the robot based on its vision system.

In addition, in order to simplify the calibration process, objects with regular graphics or easily identifiable information, such as road signs and traffic signs, can also be utilized to calibrate the camera deployed on the vehicle, in the examples of the present disclosure, the conventional calibration plates are adopted to describe the camera calibration process. However, it is not limited to using the conventional calibration plates to achieve the calibration process. In particular, the camera calibration can be correspondingly implemented according to the characteristics or limitations of the carrier on which the camera is deployed.

After the image acquisition device is calibrated through the calibration method of the foregoing examples, it may use data collected by the calibrated image acquisition device for ranging, positioning, or automatic driving control. For example, when using the data collected by the calibrated image acquisition device to control the automatic driving, it specifically includes: collecting the environmental information around the vehicle through the calibrated vehicle-mounted camera; determining a current location of the vehicle based on the collected environmental information, and controlling the vehicle based on the current location of the vehicle, such as controlling the vehicle to slow down, to brake, or to take a turning. As the calibration accuracy of the vehicle-mounted camera has been improved, the collected environmental information around the vehicle is also more accurate, which improves a positioning accuracy of the vehicle, thereby improving a control accuracy when controlling the vehicle to slow down, to brake or to take a turning and improving the safety of the unmanned driving.

FIG. 9 is a schematic structural diagram of a calibration apparatus provided by an example of the present disclosure. The calibration apparatus provided by the example of the present disclosure can perform the processing flows provided in the calibration method examples of the image acquisition device. As illustrated in FIG. 9, the calibration apparatus 90 includes an obtaining module 91, a detecting module 92, and a calibrating module 93. The obtaining module 91 is configured to obtain one or more images collected by an image acquisition device, where the one or more images include information of a plurality of calibration plates with different position-orientation information and without being shaded by each other. The detecting module 92 is configured to detect corner points corresponding to the plurality of calibration plates in each of the one or more images. The calibrating module 93 is configured to calibrate the image acquisition device based on the detected corner points.

Alternatively or additionally, the image acquisition device includes a monocular camera, and the one or more images include at least one image collected by the monocular camera; and when calibrating the image acquisition device based on the detected corner points, the calibrating module 93 is specifically configured to determine intrinsic parameters and/or extrinsic parameters of the monocular camera based on the detected corner points.

Alternatively or additionally, the image acquisition device includes a binocular camera, and the one or more images includes a first image collected using a first camera lens of the binocular camera and a second image collected using a second camera lens of the binocular camera; and when calibrating the image acquisition device based on the detected corner points, the calibrating module 93 is specifically configured to match corner points detected in the first image with corner points detected in the second image, and determine intrinsic parameters and/or extrinsic parameters of the binocular camera based on the corner points that have been successfully matched.

Alternatively or additionally, when matching the corner points detected in the first image with the corner points detected in the second image, the calibrating module 93 is specifically configured to: match the plurality of calibration plates involved in the first image with the plurality of calibration plates involved in the second image; and match the corner points corresponding to lattice points of the plurality of calibration plates in the first image with the corner points corresponding to the lattice points of the plurality of calibration plates in the second image.

Alternatively or additionally, the detecting module 92 is further configured to determine corner point candidates in the one or more images; and cluster the corner point candidates in the one or more images to obtain the corner points corresponding to the plurality of calibration plates in the one or more images.

Alternatively or additionally, the apparatus 90 further include a correcting module 94, which is configured to correct positions of the clustered corner points that correspond to three or more lattice points on the calibration plates based on a straight line constraint relationship of the three or more lattice points.

Alternatively or additionally, the calibrating module 93 is further configured to determine a disparity between the first image and the second image; and match the plurality of calibration plates involved in the first image with the plurality of calibration plates involved in the second image based on the disparity.

Alternatively or additionally, the calibrating module 93 is further configured to determine an overall displacement of reflections of the plurality of calibration plates in the second image with respect to reflections of the plurality of calibration plates in the first image, and determine the overall displacement as the disparity.

Alternatively or additionally, the calibrating module 93 is further configured to obtain a binocular disparity of the binocular camera, and determine the binocular disparity of the binocular camera as the disparity between the first image and the second image.

Alternatively or additionally, the calibrating module 93 is further configured to determine a first position coordinate in the first image corresponding to a preset position of each calibration plate of the plurality of calibration plates; determine a second position coordinate in the second image corresponding to the preset position based on the first position coordinate and the disparity between the first image and the second image; and determine that the calibration plate indicated by the second position coordinate in the second image is matched with the calibration plate indicated by the first position coordinate in the first image, so as to determine a matching relationship of each calibration plate of the plurality of calibration plates between the first image and the second image.

Alternatively or additionally, the calibrating module 93 is further configured to determine, based on coordinates of the detected corner points in the first image and the disparity between the first image and the second image, the corner points in the second image that correspond to the corner points in the first image, so as to match the orientations of the matched calibration plates involved in the first image and the second image.

Alternatively or additionally, the calibrating module 93 is further configured to in response to failing to determine the corner points in the second image that correspond to the corner points in the first image, transpose and/or rotate a matrix of the corner points in the second image at least once until the corresponding corner points are matched, so as to match the orientations of the matched calibration plates involved in the first image and the second image.

Alternatively or additionally, the image acquisition device is deployed on a vehicle.

Alternatively or additionally, the plurality of calibration plates are completely involved in the one or more images collected by the image acquisition device.

The calibration apparatus in the example illustrated in FIG. 9 can be used to implement the technical solutions of the foregoing method examples in a similar implementation principle and a similar technical effect, which will not be repeated here.

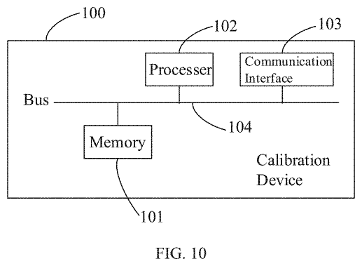

FIG. 10 is a schematic structural diagram of a calibration device provided by an example of the present disclosure. The calibration device provided by the example of the present disclosure may implement the processing flows provided in the calibration method examples of the image acquisition device. As illustrated in FIG. 10, the electronic device 100 includes: a memory 101, a processor 102, a computer program, a communication interface 103, and a bus 104. The computer program is stored in the memory 101 and is configured to perform the following method steps: obtaining one or more images collected by the image acquisition device, where the one or more images include information of a plurality of calibration plates with different position-orientation information and without being shaded by each other; detecting corner points corresponding to the plurality of calibration plates in each of the one or more images; and calibrating the image acquisition device based on the detected corner points.

Alternatively or additionally, the image acquisition device includes a monocular camera, and the one or more images include at least one image collected by the monocular camera; and when calibrating the image acquisition device based on the detected corner points, the processor 102 is specifically configured to determine intrinsic parameters and/or extrinsic parameters of the monocular camera based on the detected corner points.

Alternatively or additionally, the image acquisition device includes a binocular camera, and the one or more images includes a first image collected using a first camera lens of the binocular camera and a second image collected using a second camera lens of the binocular camera; and when calibrating the image acquisition device based on the detected corner points, the processor 102 is specifically configured to match first corner points detected in the first image with second corner points detected in the second image, and determine intrinsic parameters and/or extrinsic parameters of the binocular camera based on the first corner points and the second corner points that have been successfully matched.

Alternatively or additionally, when matching the first corner points detected in the first image with the second corner points detected in the second image, the processor 102 is specifically configured to match the plurality of calibration plates involved in the first image with the plurality of calibration plates involved in the second image; and match the corner points corresponding to lattice points of the plurality of calibration plates in the first image with the corner points corresponding to the lattice points of the plurality of calibration plates in the second image.

Alternatively or additionally, the processor 102 is further configured to determine corner point candidates in the one or more images; and cluster the corner point candidates in the one or more images to obtain the corner points corresponding to the plurality of calibration plates in the one or more images.

Alternatively or additionally, the processor 102 is further configured to correct positions of the clustered corner points that correspond to three or more lattice points on the calibration plates based on a straight line constraint relationship of the three or more lattice points.

Alternatively or additionally, the processor 102 is further configured to determine a disparity between the first image and the second image; and match the plurality of calibration plates involved in the first image with the plurality of calibration plates involved in the second image based on the disparity.

Alternatively or additionally, the processor 102 is further configured to determine an overall displacement of reflections of the plurality of calibration plates in the second image with respect to reflections of the plurality of calibration plates in the first image, and determining the overall displacement as the disparity.

Alternatively or additionally, the processor 102 is further configured to obtain a binocular disparity of the binocular camera, and determine the binocular disparity of the binocular camera as the disparity between the first image and the second image.

Alternatively or additionally, the processor 102 is further configured to determine a first position coordinate in the first image corresponding to a preset position of each calibration plate of the plurality of calibration plates; determine a second position coordinate in the second image corresponding to the preset position based on the first position coordinate and the disparity between the first image and the second image; and determine that the calibration plate indicated by the second position coordinate in the second image is matched with the calibration plate indicated by the first position coordinate in the first image, so as to determine the matching relationship of each calibration plate of the plurality of calibration plates between the first image and the second image.

Alternatively or additionally, the processor 102 is further configured to determine, based on coordinates of the corner points detected in the first image and the disparity between the first image and the second image, the corner points in the second image that correspond to the first corner points in the first image, so as to match the orientations of the matched calibration plates involved in the first image and the second image.

Alternatively or additionally, the processor 102 is further configured to in response to failing to determine the corner points in the second image that correspond to the corner points in the first image, transpose and/or rotate a matrix of the corner points in the second image at least once until the corresponding corner points are matched, so as to match the orientations of the matched calibration plates involved in the first image and the second image.

Alternatively or additionally, the image acquisition device is deployed on a vehicle.

Alternatively or additionally, the plurality of calibration plates are completely involved in the one or more images collected by the image acquisition device.

The calibration device in the example illustrated in FIG. 10 can be used to perform the technical solutions of the foregoing method examples in a similar implementation principle and a similar technical effect, which will not be repeated here.

In addition, the examples of the present disclosure also provide a computer-readable storage medium on which a computer program is stored, and the computer program is executed by one or more processors to implement the calibration methods of an image acquisition device described in the foregoing examples.

In addition, the examples of the present disclosure also provide a computer program, including computer-readable codes. When the computer-readable codes run on a device, one or more processors in the device execute the computer-readable codes to implement the methods described in the foregoing examples.

It should be understood that the apparatuses and the methods disclosed by the several examples provided by the present disclosure may be implemented in other ways. For example, the apparatus examples described above are merely illustrative. As an instance, the units are divided only based on logical functions, and there may be divided in other ways in actual implementation, for example, multiple units or components may be combined or integrated into another system, or some features can be ignored or not implemented. Moreover, the displayed or discussed mutual coupling or direct coupling or communication connection may be indirect coupling or communication connection between devices or units through some interfaces, and may be in electrical, mechanical or other forms.

The units described as separate components may or may not be physically separated, and the components displayed as units may or may not be physical units, that is, may be located in one place or distributed to multiple units in a network. Some or all of the units may be selected according to actual needs to achieve the objectives of the implementations of the examples.

In addition, the functional units in the various examples of the present disclosure may be integrated into one processing unit, or may exist as individual physical unit, or may exist by integrating two or more units together as one unit. The above-mentioned integrated units may be implemented in a form of hardware, or may be implemented in a form of hardware plus software functional units.

The above-mentioned integrated units implemented in the form of software functional units may be stored in a computer-readable storage medium. The above-mentioned software functional units stored in one storage medium include several instructions to enable a computer device (which may be a personal computer, a server, or a. network device, etc.) or one or more processors to execute parts of the steps of the methods in the various examples of the present disclosure. The aforementioned storage medium includes a medium for storing program codes, such as a U disk, a mobile hard disk, a read-only memory (ROM), a random access memory (RAM), a magnetic disk or an optical disk.

Those skilled in the art can clearly understand that, for the sake of convenience and conciseness, the description only illustrates the division of the above-mentioned functional modules as an instance. In practical applications, the above-mentioned functions can be allocated to different functional modules as required, that is, the internal structure of the apparatus can be divided into function modules in a different way to complete all or a part of the functions described above. For the specific working process of the apparatus described above, reference may be made to the corresponding process in the foregoing method examples, which will not be repeated here.

The examples of the present disclosure provide a calibration method, apparatus, system, device for an image acquisition device and a storage medium. The method includes: performing a corner point detection based on one or more images collected by the image acquisition device to determine corner points corresponding to a plurality of calibration plates involved in the one or more images, and then calibrating the image acquisition device based on the detected corner points, In a single image, there involve a plurality of calibration plates with different position-orientation information and without being shaded by each other.

Since the one or more images for calibrating the image acquisition device are collected in such a scenario that a plurality of calibration plates with different position-orientation information and without being shaded by each other are contained, the manpower that has to be consumed to manually move and/or rotate the calibration plates or manually move the image acquisition device can be saved during an image collection process. Moreover, since the single image involves the plurality of calibration plates and each calibration plate is suitable for calibrating the image acquisition device, the number of images to be processed can be greatly reduced, thereby saving resources for image processing.

In addition, since amount of information contained in the single image is equivalent to the amount of information contained in multiple images of the related art, the time spent on the image collection is saved. Meanwhile, a process occurring in the related art, screening the multiple images to select images that meet calibration requirements, can be omitted, that is, all of the one or more images collected by the image acquisition device are generally suitable for calibrating the image acquisition device, without additional manual screening of the collected images.

In addition, in an actual calibration process, the calibration plates are always kept in a static state during the one or more images being collected since the procedure of manually adjusting the calibration plates has been omitted from the collection. Therefore, for the image acquisition device with multiple camera lenses, it can effectively reduce a synchronization requirement of the multiple camera lenses, thereby improving a calibration accuracy.

Finally, it should be noted that the above examples are only used to illustrate, but not to limit, the technical solutions of the present disclosure. Although the present disclosure has been described in detail with reference to the foregoing examples, those skilled in the art should understand that the technical solutions described in the foregoing examples can still be modified, or some or all of the technical features thereof can be equivalently replaced. These modifications or replacements do not make the essence of the corresponding technical solutions deviate from the scope of the technical solutions of the examples of the present disclosure.

1. A calibration method for an image acquisition device, comprising:
obtaining one or more images collected by the image acquisition device, wherein the one or more images comprise information of a plurality of calibration plates with different position-orientation information and without being shaded by each other;
detecting corner points corresponding to the plurality of calibration plates in each of the one or more images; and
calibrating the image acquisition device based on the detected corner points.

2. The calibration method according to claim 1, wherein the image acquisition device comprises a monocular camera, and the one or more images comprise at least one image collected by the monocular camera, and
wherein calibrating the image acquisition device based on the detected corner points comprises:
determining at least one of intrinsic parameters or extrinsic parameters of the monocular camera based on the detected corner points.

3. The calibration method according to claim 1, wherein the image acquisition device comprises a binocular camera, and the one or more images comprise a first image collected using a first camera lens of the binocular camera and a second image collected using a second camera lens of the binocular camera, and
wherein calibrating the image acquisition device based on the detected corner points comprises:
matching first corner points detected in the first image with second corner points detected in the second image, and
determining at least one of intrinsic parameters or extrinsic parameters of the binocular camera based on the first corner points and the second corner points that have been successfully matched.

4. The calibration method according to claim 3, wherein matching the first corner points detected in the first image with the second corner points detected in the second image comprises:
matching the information of the plurality of calibration plates in the first image with the information of the plurality of calibration plates in the second image, and
matching the first corner points corresponding to lattice points of the plurality of calibration plates in the first image with the second corner points corresponding to the lattice points of the plurality of calibration plates in the second image.

5. The calibration method according to claim 4, wherein matching the information of the plurality of calibration plates in the first image with the information of the plurality of calibration plates in the second image comprises:
determining a disparity between the first image and the second image, and
matching the information of the plurality of calibration plates in the first image with the information of the plurality of calibration plates in the second image based on the disparity.

6. The calibration method according to claim 5, wherein determining the disparity between the first image and the second image comprises:
determining an overall displacement of reflections of the plurality of calibration plates in the second image with respect to reflections of the plurality of calibration plates in the first image, and
determining the overall displacement as the disparity.

7. The calibration method according to claim 5, wherein determining the disparity between the first image and the second image comprises:
obtaining a binocular disparity of the binocular camera, and
determining the binocular disparity of the binocular camera as the disparity between the first image and the second image.

8. The calibration method according to claim 5, wherein matching the information of the plurality of calibration plates in the first image with the information of the plurality of calibration plates in the second image based on the disparity comprises:
for each calibration plate of the plurality of calibration plates,
determining a first position coordinate in the first image corresponding to a preset position of the calibration plate,
determining a second position coordinate in the second image corresponding, to the preset position based on the first position coordinate and the disparity between the first image and the second image, and
determining that the calibration plate indicated by the second position coordinate in the second image is matched with the calibration plate indicated by the first position coordinate in the first image.

9. The calibration method according to claim 4, wherein matching the first corner points corresponding to the lattice points of the plurality of calibration plates in the first image with the second corner points corresponding to the lattice points of the plurality of calibration plates in the second image comprises:
for the lattice points of each calibration plate of the plurality of calibration plates,
determining, based on coordinates of the first corner points in the first image corresponding to the lattice points and the disparity between the first image and the second image, the second corner points in the second image that correspond to the first corner points in the first image.

10. The calibration method according to of claim 9, wherein matching the first corner points corresponding to the lattice points of the plurality of calibration plates in the first image with the second corner points corresponding to the lattice points of the plurality of calibration plates in the second image further comprises:
in response to failing to determine the second corner points in the second image that correspond to the first corner points in the first image, adjusting a matrix of the corner points in the second image at least once until corresponding second corner points are matched.

11. The calibration method according to claim I. wherein detecting the corner points corresponding to the plurality of calibration plates in each of the one or more images comprises:
for each of the one or more images,
determining corner point candidates in the image, and
clustering the corner point candidates in the image to obtain the corner points corresponding to the plurality of calibration plates in the image.

12. The calibration method according to claim 11, wherein, after clustering the corner point candidates in the image to obtain the corner points corresponding to the plurality of calibration plates in the image, the calibration method further comprises:
for each calibration plate of the plurality of calibration plates,
correcting positions of the clustered corner points that correspond to three or more lattice points on the calibration plate based on a straight line constraint relationship of the three or more lattice points.

13. The calibration method according to claim 1, wherein the image acquisition device is deployed on a vehicle.

14. The calibration method according to claim 1, wherein each of the one or more images is collected by the image acquisition device and the plurality of calibration plates with different position-orientation information, and wherein each of the plurality of calibration plates is completely visible in a field of view of the image acquisition device.

15. A system, comprising:
a calibration device for an image acquisition device, the calibration device comprising:
at least one processor; and
at least one non-transitory memory coupled to the at least one processor and storing programming instructions for execution by the at least one processor to:
obtain one or more images collected by the image acquisition device, wherein the one or more images comprise information of a plurality of calibration plates with different position-orientation information and without being shaded by each other;
detect corner points corresponding to the plurality of calibration plates in each of the one or more images; and
calibrate the image acquisition device based on the detected corner points.

16. The system according to claim 15, further comprising a carrier body, wherein the calibration device is arranged on the carrier body.

17. The system according to claim 15, further comprising:
the image acquisition device; and
the plurality of calibration plates, wherein the plurality of calibration plates are arranged with the different position-orientation information, and completely visible within a field of view of the image acquisition device.

18. The system according to claim 15, wherein the image acquisition device comprises at least one of a monocular camera or a binocular camera.

19. The system according to claim 15, wherein the image acquisition device is implemented on a vehicle.

20. A non transitory computer-readable storage medium coupled to at least one processor having machine-executable instructions stored thereon that, when executed by the at least one processor, cause the at least one processor to perform operations comprising:
obtaining one or more images collected by an image acquisition device, wherein the one or more images comprise information of a plurality of calibration plates with different position-orientation information and without being shaded by each other;
detecting corner points corresponding to the plurality of calibration plates in each of the one or more images; and
calibrating the image acquisition device based on the detected corner points.
